(19) United States
(12) Patent Application Publication
(10) Pub. No.: US 2026/0352980 A1
(43) Pub. Date: Nov. 5, 2026

(54) IMAGE SENSING DEVICE

(71) Applicant: SK hynix Inc., Gyeonggi-do (KR)

(72) Inventor: Yusuke YATA, Tokyo (JP)

(21) Appl. No.: 19/359,686

(22) Filed: Oct. 16, 2025

(30) Foreign Application Priority Data
Apr. 30, 2025 (KR) 10-2025-0056995

(51) Int. Cl. H04N 25/76; G01B 11/22; G01S 7/4865; G01S 17/894; G06T 7/521; G06T 7/55

(52) U.S. Cl. CPC H04N 25/7795; G01B 11/22; G01S 7/4865; G01S 17/894; G06T 7/521; G06T 7/55; G06T 2207/10028

(57) ABSTRACT

An image sensing device includes a pixel array configured to generate a pixel signal by detecting reflected light obtained when modulated light is reflected from a target object; a time-to-digital converter (TDC) configured to calculate a time delay between a pulse of the pixel signal and a reference pulse corresponding to the modulated light, and configured to convert the time delay into digital data; a histogramming circuit configured to generate a histogram by collecting time-dependent photoelectric conversion amount data based on the digital data; and a distance calculator configured to generate image data by calculating a distance to the target object based on the histogram and demodulating distance data based on the histogram. The image data is generated in units of a depth frame, and the depth frame includes a first subframe and a second subframe.

### CROSS-REFERENCE TO RELATED APPLICATION

This patent application claims the priority and benefits of Korean patent application No. 10-2025-0056995, filed on Apr. 30, 2025, the disclosure of which is incorporated herein by reference in its entirety.

### TECHNICAL FIELD

The embodiments of the present disclosure generally relate to an imaging device including a sensor capable of detecting a distance to a target object according to a time-of-flight (TOF) method.

### BACKGROUND

An image sensing device is a device for capturing optical images by converting light into electrical signals using a photosensitive semiconductor material which reacts to light. With the development of automotive, medical, computer and communication industries, the demand for high-performance image sensing devices is increasing in various fields such as smartphones, digital cameras, game machines, IoT (Internet of Things), robots, security cameras and medical micro cameras.

The image sensing device may be used to acquire a color image of the scene or a depth image of the scene. Recently, a TOF (time-of-flight) method has been utilized to obtain a depth image of a scene by measuring the time taken for light (e.g., infrared light) emitted by a light source to be reflected by a target object and return to a sensor, so that a distance to the target object may be calculated.

### SUMMARY

Various embodiments of the present disclosure relate to an image sensing device that can increase demodulation efficiency by improving the dealiasing operation of an image sensing device.

In accordance with an embodiment of the present disclosure, an image sensing device may include a pixel array configured to generate a pixel signal by detecting reflected light obtained when modulated light is reflected from a target object; a time-to-digital converter (TDC) configured to calculate a time delay between a pulse of the pixel signal and a reference pulse corresponding to the modulated light, and configured to convert the time delay into digital data; a histogramming circuit configured to generate a histogram by collecting time-dependent photoelectric conversion amount data based on the digital data; and a distance calculator configured to generate image data by calculating a distance to the target object based on the histogram and demodulating distance data based on the histogram. The image data may be generated in units of a depth frame, and the depth frame may include a first subframe and a second subframe.

It is to be understood that both the foregoing general description and the following detailed description of the present disclosure are illustrative and descriptive and are intended to provide further description of the embodiments of the present disclosure as claimed.

### BRIEF DESCRIPTION OF THE DRAWINGS

The above and other features and beneficial aspects of the embodiments of the present disclosure will become readily apparent with reference to the following detailed description when considered in conjunction with the accompanying drawings.

FIG. 1 is a block diagram illustrating an imaging device according to an embodiment of the present disclosure.

FIG. 2 is a block diagram illustrating a time-of-flight (TOF) sensor shown in FIG. 1 according to an embodiment of the present disclosure.

FIG. 3 is a schematic diagram illustrating a frame structure of the time-of-flight (TOF) sensor shown in FIG. 2 according to an embodiment of the present disclosure.

FIG. 4 is a schematic diagram illustrating operations of the time-of-flight (TOF) sensor shown in FIG. 3 according to an embodiment of the present disclosure.

FIG. 5 is a diagram illustrating the relationship between distance values according to sequences shown in FIG. 3 according to an embodiment of the present disclosure.

FIG. 6 is a diagram illustrating the relationship between measurement distances in subframes, which are obtained by the TOF sensor shown in FIG. 3.

FIG. 7 is a diagram illustrating the relationship between the actual distance and the measurement distances, which are obtained by the time-of-flight (TOF) sensor shown in FIG. 3.

FIG. 8 is a diagram illustrating a demodulation operation performed by the time-of-flight (TOF) sensor shown in FIG. 3 according to another embodiment of the present disclosure.

FIG. 9 is a conceptual diagram illustrating the relationship between a difference (i.e., a differential value) and a repetition cycle shown in FIG. 8 according to another embodiment of the present disclosure.

### DETAILED DESCRIPTION

The present disclosure provides embodiments of an imaging device that can detect a distance to a target object according to a time-of-flight (TOF) method that may be used in configurations to substantially address one or more technical or engineering issues and to mitigate limitations or disadvantages encountered in some imaging devices in the art. Some embodiments of the present disclosure relate to an image sensing device that can increase demodulation efficiency by improving the de-aliasing operation of an image sensing device. In recognition of the issues above, the image sensing device according to some embodiments of the present disclosure may increase the demodulation efficiency of the image sensing device.

Reference will now be made in detail to some embodiments of the present disclosure which are illustrated in the accompanying drawings. Wherever possible, the same reference numbers will be used throughout the drawings to refer to the same or like parts. Although the embodiments of the present disclosure are susceptible to various modifications and alternative forms, specific embodiments are shown in the drawings. However, the embodiments of the present disclosure should not be construed as being limited to the specific embodiments set forth herein but includes various modifications, equivalents and/or alternatives of the embodiments.

The embodiments of the present disclosure may provide a variety of advantageous effects capable of being directly or indirectly recognized by one of ordinary skill in the art.

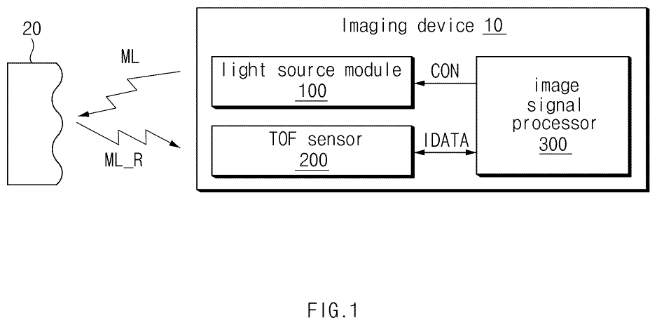

FIG. 1 is a block diagram illustrating an imaging device 10 according to an embodiment of the present disclosure.

Referring to FIG. 1, the imaging device 10 may refer to a device, for example, a digital still camera for photographing still images or a digital video camera for photographing moving images. For example, the imaging device 10 may be implemented as a Digital Single Lens Reflex (DSLR) camera, a mirrorless camera, a smartphone, and others. The imaging device 10 may include a device having both a lens and an image pickup element such that the device can capture (or photograph) a target object and can thus create an image of the target object.

The imaging device 10 may include an image signal processor 300, a light source module 100, and a time-of-flight (TOF) sensor 200.

The imaging device 10 may measure the distance to a target object 20 using the TOF (time of flight) principle that calculates the distance to the target object 20 based on the time required for light radiated from the imaging device 10 to be reflected by the target object 20 and then incident upon the imaging device 10.

A light source module 100 may emit modulated light (ML) to a target object 20 upon receiving a control signal (CON) from the image signal processor 300. The light source module 100 may be a laser diode (LD) or a light emitting diode (LED) for emitting light (e.g., infrared (IR) light or visible light) having a specific wavelength band, or may be any one of a Near Infrared Laser (NIR), a point light source, a monochromatic light source combined with a white lamp or a monochromator, and a combination of other laser sources. For example, the light source module 100 may emit infrared (IR) light having a wavelength of 800 nm to 1000 nm. In some embodiments, the following description will be given based on that the light source module 100 emits infrared (IR) light. The modulated light (ML) may be pulse light modulated with predetermined modulation characteristics (e.g., waveform, wavelength, period, amplitude, frequency, phase, duty rate, etc.). In one embodiment, the light source module 100 may include a vertical-cavity surface-emitting laser (VCSEL) light source. The VCSEL light source may correspond to a semiconductor laser diode that emits a laser in a direction perpendicular to the surface.

The TOF sensor 200 may be used to measure the distance to the target object 20 using the TOF method under the control of the image signal processor 300. In some embodiments, the TOF method may be implemented as a direct TOF method. The direct TOF method may directly measure a round-trip time from a first time where modulated light (ML) modulated with predetermined modulation characteristics is emitted to the target object 20 to a second time where reflected light (ML_R) reflected from the target object 20 is incident and detected, and may thus calculate the distance to the target object 20 by calculating the round-trip time and the speed of light.

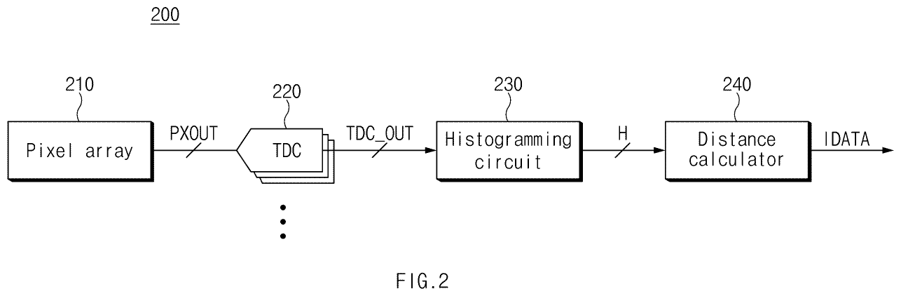

The TOF sensor 200 may operate by receiving a control signal from the image signal processor 300. The TOF sensor 200 may provide pixel data generated in the process of calculating the distance to the target object 20 to the image signal processor 300. In addition, the TOF sensor 200 may transmit the result of measuring the distance to the target object 20 to the image signal processor 300. For example, the TOF sensor 200 may transmit the round-trip time of the modulated light (ML) and the reflected light (ML_R) to the image signal processor 300. The detailed configuration and operation of the TOF sensor 200 will be described later with reference to FIG. 2.

The image signal processor 300 may collect image data (IDATA) for each pixel (i.e., per-pixel data) received from the TOF sensor 200, and may thus generate a depth image indicating the distance to the target object 20.

The image signal processor 300 may perform image signal processing for performing noise cancellation and image quality improvement on the generated image. For example, the image signal processor 300 may perform noise cancellation and image quality improvement on the depth image generated using the TOF sensor 200.

The depth image output from the image signal processor 300 may be stored in either the imaging device 10 or an internal or external memory of a device equipped with the imaging device 10 according to a user's request or through automation or may be displayed on a display according to a user's request or through automation. Alternatively, the depth image output from the image signal processor 300 may be used to control the operation of the imaging device 10 or the operation of the device equipped with the imaging device 10.

FIG. 2 is a block diagram illustrating a time-of-flight (TOF) sensor 200 shown in FIG. 1 according to an embodiment of the present disclosure.

Referring to FIG. 2, the TOF sensor 200 may include a pixel array 210, a time-to-digital converter (hereinafter referred to as “TDC”) 220, and a histogramming circuit 230. For example, the TOF sensor 200 may measure the time taken for light to be reflected by a target object and return to the sensor using a time-correlated single-photon counting (hereinafter referred to as “TCSPC”) method.

The pixel array 210 may include a plurality of pixels (PXs) arranged in a row direction and a column direction to generate a pixel signal (PXOUT). In some embodiments, a pulse signal of the pixel signal (PXOUT) generated from the pixel array 210 may be referred to as a single-photon avalanche diode (SPAD) pulse.

For example, in the pixel array 210, (N×N) pixels, where “N” is a natural number greater than or equal to 2, may be grouped to form a unit pixel (UP). The plurality of pixels (PXs) may detect incident reflected light (ML_R) and generate a pixel signal (PXOUT). The pixels (PXs) may be grouped into a macropixel unit. Here, the pixels (PXs) may be one macropixel or a plurality of macropixels may be arranged in an array structure. Here, the following description will be given on the premise that each pixel (PX) is a single-photon avalanche diode (SPAD) pixel for detecting a distance to the target object 20 according to the direct time-of-flight (TOF) method, but the embodiments are not limited thereto.

The TDC 220 may calculate a time delay between a pulse of the pixel signal (PXOUT) output from the pixel array 210 and a reference pulse of the modulated light (ML), and may convert the resultant pulse into a digital value corresponding to the time delay to generate TDC data (TDC_OUT).

For example, the TDC 220 may include digital logic configured to calculate a time delay between the pulse of the pixel signal (PXOUT) and the reference pulse to generate digital data, and an output buffer configured to store the generated digital data. The TDC 220 may collectively refer to the digital logic and the output buffer. The TDC 220 may be a converter configured to convert information about the arrival time of photons received by a plurality of SPAD elements into a digital signal. In some embodiments, the TDC 220 may be a TDC block including a plurality of TDCs.

The histogramming circuit 230 may collect photoelectric conversion amount data over time based on the TDC data (TDC_OUT), and may generate a histogram (H). Here, the histogram may correspond to a graph that accumulates pixel data or a photoelectric conversion amount generated by one pixel over time and displays the resultant data. The histogramming circuit 230 may accumulate and store timestamp data in timebins based on the TDC data (TDC_OUT), and may determine a bin having a peak value. Although the present disclosure has described the histogramming circuit 230 and the TDC 220 as being separate configurations, other embodiments are also possible, and it should be noted that the histogramming circuit 230 may also be included in the TDC 220 as needed.

The distance calculator 240 may calculate the distance based on the histogram (H) received from the histogramming circuit 230 and generate image data (IDATA) including the distance information. That is, the distance calculator 240 may calculate the distance between the TOF sensor 200 and the target object 20 based on the histogram (H) related to the detection timing point of the reflected light (ML_R).

The TDC 220 may start a counting operation for calculating a time delay of a pulse in synchronization with irradiation of the modulated light (ML). Then, when the reflected light (ML_R) is incident upon the pixel array 210, the avalanche breakdown phenomenon according to photons may occur in the SPAD element. The TDC 220 may count information about the arrival time of the photons received by the SPAD element, may convert the counted information into a digital signal (e.g., timing code), and may output TDC data (TDC_OUT).

The histogramming circuit 230 may count up (sum) bins of the histogram (H) corresponding to the counting value based on the TDC data (TDC_OUT). After repeating the above operation, the histogramming circuit 230 may detect a bin that has a peak higher than the stored histogram (H). The distance calculator 240 may measure the distance by considering a timing point corresponding to the bin of the histogram as an incidence timing point of the reflected light (ML_R).

In this case, a maximum distance that can be measured by the distance calculator 240 may be proportional to a clock frequency and the number of bins that can be used in the histogram (H). The distance resolution and precision may be proportional to a clock cycle that is a time width corresponding to a single bin width.

The measured distance and the measurement accuracy may vary depending on the number of bins. For example, when measuring the distance by setting the number of bins to “10”, the clock frequency may be doubled to measure the distance with double precision. Then, the single bin width may be halved, and the number of bins for measuring the same distance may be doubled, that is, “20”.

That is, when measuring a long distance with high precision, a high clock frequency and a large number of bins are required, so that a high-capacity memory may be required. In this case, the area of the device may increase to embed a large number of histograms in the device. As a result, a chip size and costs may increase. If the chip size is not increased, the distance may not be measured accurately and the precision may not be secured.

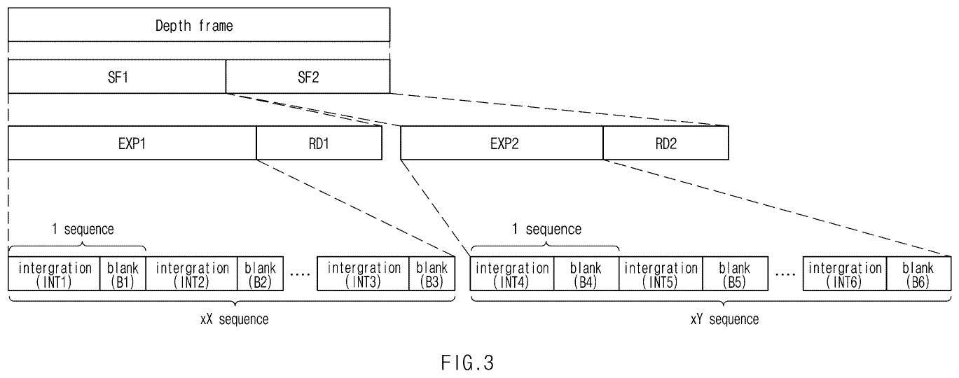

Accordingly, the TOF sensor 200 according to the present disclosure may store the distance information measured by the TOF sensor 200 on a subframe basis (in units of a subframe). In addition, the distance data of more than the number of bins may be demodulated from the distance data of two or more subframes having different numbers of bins. That is, the distance data may be demodulated by determining the relationship between the actual distance and each of the first distance data measured by the first subframe and the second distance data measured by the second subframe. According to another embodiment, the distance data may be demodulated by calculating a peak position of the histogram and calculating a difference between two peak positions to determine a repetition cycle of each subframe. The detailed configuration and operation of the TOF sensor 200 will be described later with reference to FIGS. 3 to 9.

FIG. 3 is a schematic diagram illustrating a frame structure of the time-of-flight (TOF) sensor shown in FIG. 2 according to an embodiment of the present disclosure.

Referring to FIG. 3, the TOF sensor 200 may operate on a depth-frame basis to obtain depth data indicating the distance to the target object 20. That is, the TOF sensor 200 may acquire depth data after performing an operation corresponding to the depth frame.

The TOF sensor 200 may collect image data (IDATA) for each pixel, and may store the collected image data on a subframe basis. That is, the image data (IDATA) stored in the TOF sensor 200 may be represented by a distance frame (or a depth frame). In this case, the distance frame may represent a state in which the TOF sensor 200 performs an operation of obtaining a distance (or depth) image.

The distance frame may include two frames, i.e., a first subframe (SF1) and a second subframe (SF2).

For example, the first subframe (SF1) may include an exposure section (EXP1) and a signal processing and readout section (RD1).

Here, the exposure section (EXP1) may be a section in which the pixel array 210 detects the reflected light (ML_R) generated after the modulated light (ML) output from the TOF sensor 200 is reflected from the target object 20 and accumulates the generated photocharges in the pixel. The exposure section (EXP1) may be a section in which the histogramming operation is performed by receiving the reflected light (ML_R) and measuring the timing point at which light is received.

The readout section (RD1) may be a section in which the TOF sensor 200 generates image data (IDATA) based on an electrical signal corresponding to photocharges accumulated in the pixel array 210 and transmits the image data (IDATA) to the image signal processor 300. The readout section (RD1) may be a section in which the TOF sensor converts a pixel signal generated by the pixel array 210 into a digital signal and outputs the image data (IDATA).

The exposure section (EXP1) may include integration sections (INT1~INT3) and blank sections (B1~B3).

In this case, the integration sections (INT1~INT3) may be sections in which the TOF sensor 200 generates and accumulates photocharges. The TDC 220 and the histogramming circuit 230 may operate during the integration sections (INT1~INT3).

The blank sections (B1~B3) may exist between the time when the TOF sensor 200 generates one image data and another time when the next image data is generated. The blank sections (B1~B3) may be a period in which the TDC 220 is reset. According to an embodiment, the blank sections (B1~B3) may be time sections in which the histogram (H) generated by the histogramming circuit 230 is output to the distance calculator 240.

The integration sections (INT) and the blank sections (B) may be set as one sequence section. Accordingly, in the exposure section (EXP1), the integration sections and the blank sections may be repeated multiple times during the X-sequence section.

Similarly, the second subframe (SF2) may include an exposure section (EXP2), and a signal processing and readout section (RD2). The exposure section (EXP2) may include the integration sections (INT4~INT6) and the blank sections (B4~B6). Therefore, in the exposure section (EXP2), the integration sections and the blank sections may be repeated multiple times during the Y-sequence section.

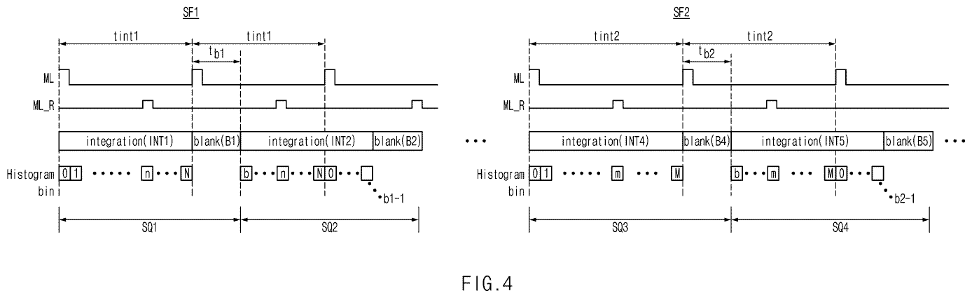

FIG. 4 is a schematic diagram illustrating operations of the time-of-flight (TOF) sensor shown in FIG. 3 according to an embodiment of the present disclosure.

Referring to FIG. 4, a first sequence (SQ1) in the first subframe (SF1) may include the integration section (INT1) and the blank section (B1). In the first subframe (SF1), a second sequence (SQ2) may include the integration section (INT2) and the blank section (B2). In addition, in the second subframe (SF2), a third sequence (SQ3) may include the integration section (INT4) and the blank section (B4). In the second subframe (SF2), a fourth sequence (SQ4) may include the integration section (INT5) and the blank section (B5).

However, even when light is incident upon the blank section, the count value may not be reflected in the histogram because the TDC 220 and the histogramming circuit 230 do not operate. That is, the blank section may be a section where distance measurement is impossible and the image data is not output and a signal is output as a low signal. Accordingly, even when an object is detected during the measurement process of the actual distance, the object is not measured in the blank section, so that this object may be calculated as a random value due to noise in the distance measurement result.

Accordingly, the TOF sensor 200 according to the present disclosure may perform shifting of the number of bins of the histogram that are counted up by the blank section (B1, B4) whenever the integration section (INT2, INT5) starts in a specific sequence (SQ2, SQ4) of each subframe (SF1, SF2), so that the TOF sensor 200 may demodulate distance data of more than the number of bins from the distance data of the subframes (SF1, SF2).

Specifically, a period in which the modulated light (ML) is irradiated in the first subframe (SF1) may be defined as a light-emitting period (tᵢₙₜ₁). In this case, the light-emitting period (tᵢₙₜ₁) may refer to a period in which the pulse of the modulated light (ML) is repeated and may also be called a pulse period. The light source module 100 may repeat the emission of the modulated light (ML) with the light-emitting period (tᵢₙₜ₁) within the first subframe (SF1).

During the integration section (INT1) of the first subframe (SF1), the histogramming circuit 230 may generate the histogram (H). The number of bins of the histogram (H) corresponding to the light-emitting period (tᵢₙₜ₁) may be defined as “N”. The pulse of the reflected light (ML_R) may be generated whenever the reflected light (ML_R) is detected by the TOF sensor 200.

The period in which the modulated light (ML) is irradiated in the second subframe (SF2) may be defined as a light-emitting period (tᵢₙₜ₂). The light-emitting period (tᵢₙₜ₂) in the second subframe (SF2) may be longer than the light-emitting period (tᵢₙₜ₁) in the first subframe (SF1).

The light source module 100 may repeat the emission of the modulated light (ML) with the light-emitting period (tᵢₙₜ₂) in the second subframe (SF2). During the integration section (INT4) of the second subframe (SF2), the histogramming circuit 230 may generate the histogram (H). In addition, the number of bins of the histogram (H) corresponding to the light-emitting period (tᵢₙₜ₂) may be defined as “M”. Here, N and M may be different positive natural numbers. Then, the width of bins in the first subframe (SF1) may be equal to the width of bins in the second subframe (SF2), and the width of one bin may be defined as “Wb”.

The light-emitting period (tᵢₙₜ₁) of the first subframe (SF1) may be calculated by the following equation 1.

tᵢₙₜ₁=N×Wb [Equation 1]

Referring to Equation 1, the light-emitting period (tᵢₙₜ₁) may be obtained by multiplying one bin width (Wb) by the total number (N) of bins of the histogram.

Then, the light-emitting period (tᵢₙₜ₂) of the second subframe (SF2) may be calculated by the following equation 2.

tᵢₙₜ₂=M×Wb [Equation 2]

Referring to Equation 2, the light-emitting period (tᵢₙₜ₂) may be obtained by multiplying one bin width (Wb) by the total number (M) of bins of the histogram.

The blank section in the first subframe (SF1) may be defined as “t_{b1}”, and the blank section in the second subframe (SF2) may be defined as “t_{b2}”.

When the reflected light (ML_R) is incident upon the pixel array, an initial value of the bin that is counted up in the histogramming circuit 230 for each integration section may be shifted by a value corresponding to the blank section. That is, each integration section may start after the blank section (t_{b1}) is shifted from the time when the reflected light (ML_R) is incident.

For example, the width (t_{b1}) of the blank section corresponds to the width (Wb) of 5 bins, and the initial value of the bin corresponding to the histogram in the first sequence (SQ1) is set to zero “0”. As a result, in the second sequence (SQ2), the initial value (i.e., “b” value) of the bin may be “5”, and in the next sequence, the initial value of the bin may be “10”. The number of bins of the histogram to be counted in the integration section (INT1) may be “N”. The number of bins of the histogram to be counted in the integration section (INT2) may be denoted by “b1-1”. The total number of bins of the histogram to be counted in the integration section (INT2) may be the same as the integration section (INT1). For example, the number (b1) of bins in the first subframe (SF1) may be defined as “20”. Bins of the bin width corresponding to the blank section (t_{b1}) in which distance measurement is impossible in the first sequence (SQ1) may be shifted to the integration section (INT2) of the second sequence (SQ2), and may then be removed.

For example, the width (t_{b2}) of the blank section corresponds to the width (Wb) of 5 bins, and the initial value of the bin corresponding to the histogram in the third sequence (SQ3) is set to zero “0”. As a result, in the fourth sequence (SQ4), the initial value (i.e., “b” value) of the bin may be “5”, and in the next sequence, the initial value of the bin may be “10”. The number of bins of the histogram to be counted in the integration section (INT4) may be “N”. The number of bins of the histogram to be counted in the integration section (INT5) may be denoted by “b2-1”. The total number of bins of the histogram to be counted in the integration section (INT5) may be the same as the integration section (INT4). For example, the number (b2) of bins in the second subframe (SF2) may be defined as “30”. Bins of the bin width corresponding to the blank section (t_{b2}) in which distance measurement is impossible in the third sequence (SQ3) may be shifted to the integration section (INT5) of the fourth sequence (SQ4), and may then be removed.

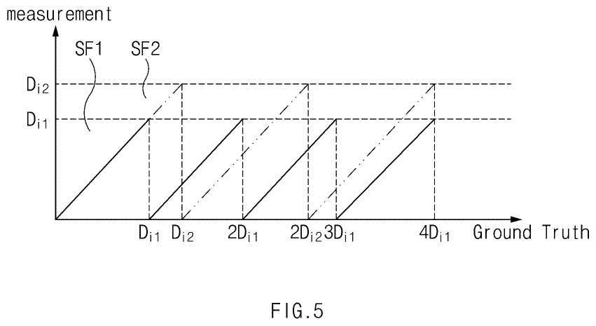

FIG. 5 is a diagram illustrating the relationship between distance values according to sequences shown in FIG. 3 according to an embodiment of the present disclosure.

Referring to FIG. 5, a value in a horizontal direction (X-axis direction) in the graph may represent the actual distance (denoted by “Ground Truth” in FIG. 5) between the TOF sensor 200 and the target object 20. A value in a vertical direction (Y-axis direction) in the graph may represent the distance (denoted by “measurement” in FIG. 5) measured by the TOF sensor 200. In the graph, the first subframe (SF1) interval and the second subframe (SF2) interval are different from each other, but the first subframe (SF1) interval and the second subframe (SF2) interval may overlap each other within the same time scale. In this way, the measurement distances can be depicted using the first subframe (SF1) interval and the second subframe (SF2) interval.

In the first subframe (SF1), the distance may be repeatedly measured with a time cycle (Dᵢ₁). When the distance is measured with the time cycle (Dᵢ₁) in the first subframe (SF1), the actual distance (Ground Truth) may be denoted by Dᵢ₁, 2Dᵢ₁, 3Dᵢ₁, and 4Dᵢ₁. In the second subframe (SF2), the distance may be repeatedly measured with the time cycle (Dᵢ₂). When the distance is measured with the time cycle (Dᵢ₂) in the second subframe (SF2), the actual distance (Ground Truth) may be denoted by Dᵢ₂, 2Dᵢ₂, and 4Dᵢ₁. The time cycle (Dᵢ₂) may have a longer update cycle than the time cycle (Dᵢ₁). Here, 4Dᵢ₁ may be 3Dᵢ₂ (not shown), which is the distance measured with the time cycle (Dᵢ₂).

In the actual distance (4Dᵢ₁), the Dᵢ₁ distance of the first subframe (SF1) and the Dᵢ₂ distance of the second subframe (SF2) may have the same waveform. For example, a maximum distance measurable by demodulation may be obtained using the least common multiple (LCM) method. According to the LCM method, the distance to the actual distance (4Dᵢ₁) can be measured by multiplying the Di distance by the Dᵢ₂ distance.

For example, the measurable distance (Dᵢ₁ cycle) in the first subframe (SF1) is 2 meters (2 m) and that the measurable distance (Dᵢ₂ period) in the second subframe (SF2) is 3 m. Then, when the least common multiple (LCM) scheme is applied to a maximum distance measurable by demodulation, the maximum distance may be 6 meters (6 m) obtained by multiplying 2 meters (2 m) by 3 meters (3 m).

In this way, the method for demodulating one distance data from at least two distance data pieces can be defined as dealiasing. The dealiasing method may represent a method for expanding a clear range according to the least common multiple (LCM) of two data pieces by using two or more different distance data pieces when there is ambiguity in the distance.

Since the blank section in which the distance measurement is impossible is excluded from the range of the demodulation operation, the distance to the actual distance (4Dᵢ₁) can be demodulated using only the Dᵢ₁ distance and the Dᵢ₂ distance.

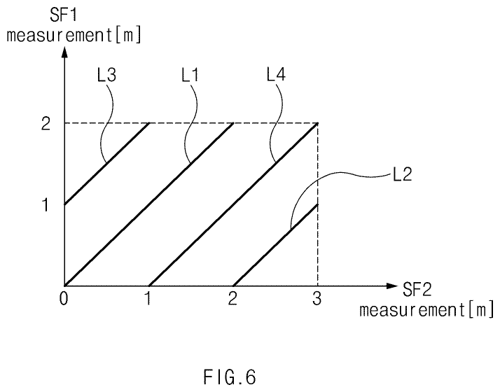

FIG. 6 is a diagram illustrating the relationship between measurement distances in subframes, which are obtained by the TOF sensor shown in FIG. 3.

Referring to FIG. 6, the relationship between the measured distances of the subframes (SF1, SF2) may be represented as a graph. In the graph, the horizontal direction (X-axis direction) value may represent the distance measured in the second subframe (SF2), and the vertical direction (Y-axis direction) value may represent the distance measured in the first subframe (SF1).

For example, the measurable distance in the first subframe (SF1) is 2 m and the measurable distance in the second subframe (SF2) is 3 m. Hence, the maximum measurable distance by demodulation is 6 m.

Define the line segments drawn by the relationship shown in the graph as Lines L1~L4. For example, Line L1 may correspond to 0~2 meters of the actual distance, Line L2 may correspond to 2~3 meters of the actual distance, Line L3 may correspond to 3~4 meters of the actual distance, and Line L4 may correspond to 4~6 meters of the actual distance.

As a result, the number of repetitions of the distance cycle of each of the subframes (SF1, SF2) within Line L1 (e.g., the actual distance of 0~2 meters) may be 0 times. The number of repetitions of the distance cycle of the subframe (SF1) within Line L2 (e.g., the actual distance of 2~3 meters) may be 1 times, and the number of repetitions of the distance cycle of the subframe (SF2) within Line L2 (e.g., the actual distance of 2~3 meters) may be 0 times. The number of repetitions of the distance cycle of the subframe (SF1) within Line L3 (e.g., the actual distance of 3~4 meters) may be 1 times, and the number of repetitions of the distance cycle of the subframe (SF2) within Line L3 (e.g., the actual distance of 3~4 meters) may be 1 times. The number of repetitions of the distance cycle of the subframe (SF1) within Line L4 (e.g., the actual distance of 4~6 meters) may be 2 times, and the number of repetitions of the distance cycle of the subframe (SF2) within Line L4 (e.g., the actual distance of 4~6 meters) may be 1 times.

For example, the distance value of the first subframe (SF1) is 1 m and the distance value of the second subframe (SF2) is 2 m, it can be seen that the differential value is “−1” and the repetition numbers of repetition cycles of the subframes (SF1, SF2) are respectively set to 2 and 1. Accordingly, the actual distance may be calculated as 5 m (i.e., 1+(2×2)=5 m). Here, the number corresponding to the distance value of 1 meter in the sub-frame (SF1) can be assumed as “1” and the number of repetitions can be assumed as “2”. In addition, the number corresponding to the distance value of 2 meters in the sub-frame (SF2) can be assumed as “2” and the number of repetitions can be assumed as “1”.

Accordingly, the distance calculator 240 according to the present disclosure may determine the relevance of the measured distances of the subframes (SF1, SF2) to specify the measured distance values. The distance calculator 240 may determine which line in the graph is associated with the measured distance value, may determine which cycle the distance measurement value of each of the subframes (SF1, SF2) is related to, and may thus perform data demodulation.

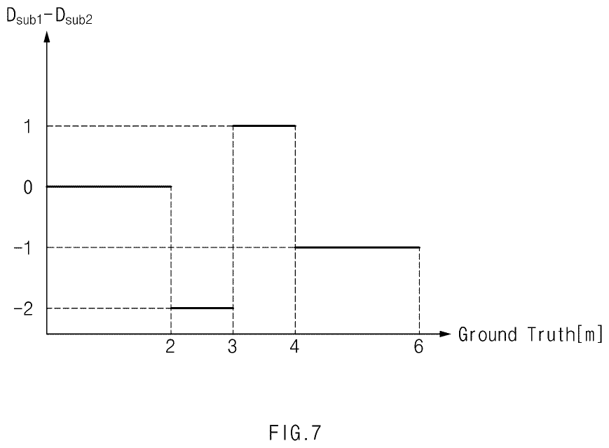

FIG. 7 is a diagram illustrating the relationship between the actual distance and the measurement distances, which are obtained by the TOF sensor 200 shown in FIG. 3.

Referring to FIG. 7, the relationship between the actual distance and the measured distance may be represented as a graph. In the graph, the value of the horizontal direction (X-axis direction) may represent the actual distance, and the value of the vertical direction (Y-axis direction) may represent a difference between the distances measured in the subframes (SF1, SF2).

The repetition number of repetition cycles of each of the subframes (SF1, SF2) may be calculated based on the difference of the measured distance values between the subframes (SF1, SF2), so that the actual distance (Ground Truth) can be demodulated. For example, the distance measured by the first subframe (SF1) will hereinafter be referred to as “D_{sub1}”, and the distance measured by the second subframe (SF2) will hereinafter be referred to as “D_{sub2}”. Accordingly, it can be seen that the differential value (i.e., D_{sub1}−D_{sub2}) of “0” corresponds to Line L1, the differential value (i.e., D_{sub1}−D_{sub2}) of “−2” corresponds to Line L2, the differential value (i.e., D_{sub1}−D_{sub2}) of “1” corresponds to Line L3, and the differential value (i.e., D_{sub1}−D_{sub2}) of “−1” corresponds to Line L4.

In the process of measuring the actual distance, errors may occur in the distance measurement value due to noise, etc. As a result, differential values (D_{sub1}−D_{sub2}) between the subframes (SF1, SF2) may not coincide with values on lines of FIG. 7.

Accordingly, after obtaining the differential value (i.e., D_{sub1}−D_{sub2}) between the subframes (SF1, SF2), it is necessary to specify the repetition cycle by determining which one of the preset differential values is closest to the obtained differential value (i.e., D_{sub1}−D_{sub2}).

For example, when the differential value (i.e., D_{sub1}−D_{sub2}) is calculated as “1.2”, it can be determined that the calculated value is closest to the differential value “1” so that the calculated value corresponds to Line 3 (L3) of FIG. 6. Furthermore, in this case, the finally calculated distance value may be obtained by averaging the distance value demodulated from the measurement value of the first subframe (SF1) and the distance value demodulated from the measurement value of the second subframe (SF2).

That is, the maximum measurement distance of the first subframe (SF1) is set to Dₘ₁, the maximum measurement distance of the second subframe (SF2) is set to Dₘ₂, and the repetition numbers of repetition cycles, which are calculated from such differential values in the first and second subframes (SF1, SF2), are denoted by R1 and R2, respectively. Then, the maximum measurement distance (D) that is demodulated and calculated can be calculated by the following equation 3.

D=(D_{sub1}+Dₘ₁×R1+D_{sub2}+Dₘ₂×R2)/2 [Equation 3]

Accordingly, in the present disclosure, the distance precision can be improved by using data of two or more subframes (SF1, SF2) in the process of calculating the distance value.

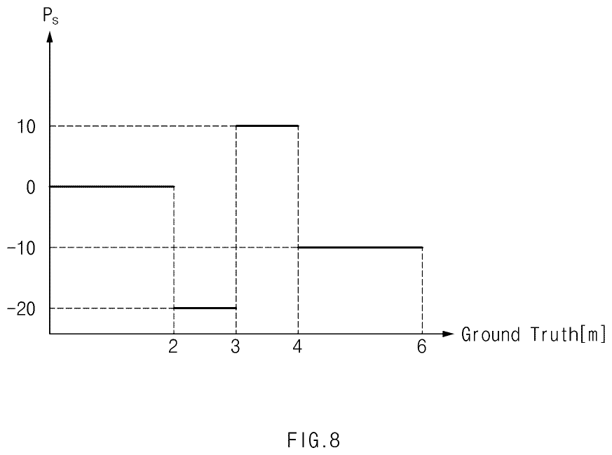

FIG. 8 is a diagram illustrating a demodulation operation performed by the TOF sensor 200 shown in FIG. 3 according to another embodiment of the present disclosure.

Referring to FIG. 8, a value in the horizontal direction (X-axis direction) in the graph may represent the actual distance (Ground Truth), and a value in the vertical direction (Y-axis direction) may represent a differential value (i.e., difference) (Pₛ) between the distance measured in the subframe (SF1) and the distance measured in the subframe (SF2).

If the embodiment of FIG. 7 described above is used to perform the demodulation operation by calculating a distance value for each subframe (SF1, SF2), the embodiment of FIG. 8 may illustrate an example of performing the demodulation operation from a peak bin position.

The TDC 220 and the histogramming circuit 230 may detect the peak position of the histogram, may convert the detected value into a distance value, and may thus calculate the distance value. For example, as the simplest method, the peak position (Pb) is multiplied by each of the bin width and the speed of light, and the resultant value of such multiplication is divided by “2”, so that the distance value can be calculated.

However, according to the above-described calculation method, the resolution of the distance may be limited by the bin width. Therefore, when high-precision and high-resolution distance measurement data is required, a method for calculating the distance value by performing centroid calculation may be used. The centroid calculation method may calculate the position of an effective peak bin based on the count value of the peak bin and the count values of bins located before and after the effective peak bin. When using the centroid calculation method, reducing the number of processing times as much as possible may be advantageous in terms of power consumption or frame rate.

For example, the peak position of the histogram of the first subframe (SF1) may be “P_{b1}”, and the peak position of the histogram of the second subframe (SF2) may be “P_{b2}”. For example, the peak positions (P_{b1}, P_{b2}) may be applied to the centroid calculation, so that the differential value (Pₛ) between the peak positions (P_{b1}, P_{b2}) can be calculated. For example, if there is no difference (peak displacement value) between the peak positions (P_{b1}, P_{b2}), the differential value (Pₛ) may be zero “0”. Likewise, if there is a difference (peak displacement value) between the peak positions (P_{b1}, P_{b2}), the differential value (Pₛ) may be calculated as a value such as “−20”, “10”, “−10”, or the like.

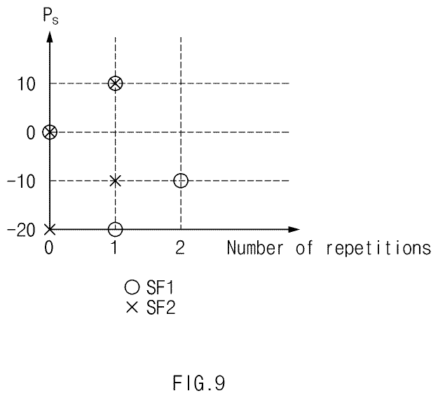

FIG. 9 is a conceptual diagram illustrating the relationship between the difference (differential value) and the repetition cycle shown in FIG. 8 according to another embodiment of the present disclosure.

Referring to FIG. 9, in the graph, the value in the horizontal direction (X-axis direction) may represent the repetition number of repetition cycle, and the value in the vertical direction (Y-axis direction) may represent the differential value (Pₛ) calculated in FIG. 8.

The repetition number of repetition cycle of each subframe (SF1, SF2) may be determined from the differential value (Pₛ) of the peak positions obtained in FIG. 8. For example, in the graph of FIG. 9, the circle mark (◯) may represent the differential value (Pₛ) and the repetition number of repetition cycle in the first subframe (SF1), and the X mark (x) may represent the differential value (Pₛ) and the repetition number of repetition cycle in the second subframe (SF2).

However, the peak position of the histogram may also deviate depending on the noise. Accordingly, it is determined which one of the predetermined differential values is closest to the differential value (Pₛ), so that the repetition number of repetition cycle of each subframe (SF1, SF2) may be determined according to the result of such determination.

For example, the repetition number of repetition cycle obtained from the differential value (Pₛ) in the subframe (SF1) is “R1” and the repetition number of repetition cycle obtained from the differential value (Pₛ) in the subframe (SF2) is “R2”. The peak bin position (P_{bd1}) obtained after the demodulation operation may be calculated by the following equation 4, and the peak bin position (P_{bd2}) obtained after the demodulation operation may be calculated by the following equation 5.

P_{bd1}=P_{b1}+B1×R1 [Equation 4]

P_{bd2}=P_{b2}+B2×R2 [Equation 5]

In addition, when calculating the distance (D) from each of the peak bin positions (P_{bd1}, P_{bd2}), the distance (D) can be calculated by the following equation 6.

$$D = \frac{c}{2} ( {P}_{b d 1} + {P}_{b d 2} ) \cdot WB \qquad [ Equation 6 ]$$

In Equation 6, “c” denotes the speed of light, and “WB” denotes the bin width.

According to another embodiment, when the centroid calculation is calculated, addition between histograms can be performed. For example, when the centroid calculation is performed in the range of “±Nc” centered on the peak bin positions (P_{bd1}, P_{bd2}), histograms in the ranges of Equations 7, 8, 9 and 10 may be added (or summed).

P_{b1}−N_{c}~P_{b1}+N_{c}+P_{bd2}−P_{bd1}(P_{bd1}≤P_{bd2}) [Equation 7]

P_{b1}−N_{c}~P_{bd1}+P_{bd2}~P_{b1}+N_{c}(P_{bd1}>P_{bd2}) [Equation 8]

Equation 7 and Equation 8 may represent the addition range for use in the first subframe (SF1).

P_{b2}−N_{c}~P_{bd2}+P_{bd1}~P_{b1}+N_{c}(P_{bd1}≤P_{bd2}) [Equation 9]

P_{b2}−N_{c}~P_{b2}+P_{bd1}−P_{bd2}(P_{bd1}>P_{bd2}) [Equation 10]

Equation 9 and Equation 10 may represent the addition range for use in the second subframe (SF2). In the above equations 7 through 10, the “~” notation indicates that the peak position Pb1 of the first subframe (SF1) and the peak position Pb2 of the second subframe (SF2) can vary.

After summing (adding) the values of the histogram as described above, the centroid calculation is performed as in Equation 11 to obtain the effective peak position (P_{eff}), thereby calculating a maximum measurement distance (D).

$$D = \frac{c}{2} ( {P}_{eff} ) \cdot WB \qquad [ Equation 11 ]$$

In the same manner as described above, distance data greater than or equal to the maximum measurable distance of each of the subframes (SF1, SF2) may be demodulated rather than data of the subframes (SF1, SF2) having different numbers of bins. Since a large amount of distance data can be obtained from the histogram having a smaller number of bins, the distance measurement range can be increased while improving the time resolution.

As is apparent from the above description, the image sensing device according to the embodiments of the present disclosure may increase the demodulation efficiency of the image sensing device.

The embodiments of the present disclosure may provide a variety of advantageous effects capable of being directly or indirectly recognized by one of ordinary skill in the art.

Although a number of illustrative embodiments have been described, it should be understood that modifications and enhancements to the disclosed embodiments and other embodiments can be devised based on what is described and/or illustrated in the present disclosure. Therefore, the embodiments of the present disclosure should not be limited to the above-described embodiments but should include the equivalents thereof. Furthermore, the embodiments may be combined to form additional embodiments.

What is claimed is:

1. An image sensing device comprising:
a pixel array configured to generate a pixel signal by detecting reflected light obtained when modulated light is reflected from a target object;
a time-to-digital converter (TDC) configured to calculate a time delay between a pulse of the pixel signal and a reference pulse corresponding to the modulated light, and convert the time delay into digital data;
a histogramming circuit configured to generate a histogram by collecting time-dependent photoelectric conversion amount data based on the digital data; and
a distance calculator configured to generate image data by calculating a distance to the target object based on the histogram and demodulating distance data based on the histogram,
wherein:
the image data is generated in units of a depth frame; and
the depth frame includes a first subframe and a second subframe.

2. The image sensing device according to claim 1, wherein:
in the first subframe, the modulated light has a first light-emitting period; and
in the second subframe, the modulated light has a second light-emitting period.

3. The image sensing device according to claim 2, wherein the first light-emitting period is equal to a value obtained when a total number of bins of the histogram corresponding to the first subframe is multiplied by a single bin width.

4. The image sensing device according to claim 2, wherein the second light-emitting period is equal to a value obtained when a total number of bins of the histogram corresponding to the second subframe is multiplied by a single bin width.

5. The image sensing device according to claim 1, wherein the first subframe includes:
a first exposure section configured to accumulate photocharges generated by detecting the reflected light; and
a first readout section configured to generate the image data corresponding to the accumulated photocharges.

6. The image sensing device according to claim 5, wherein the first exposure section includes:
a first integration section in which the photocharges are accumulated;
a first blank section in which the time-to-digital converter (TDC) is reset after lapse of the first integration section;
a second integration section in which the photocharges are accumulated after lapse of the first blank section; and
a second blank section in which the time-to-digital converter (TDC) is reset after lapse of the second integration section.

7. The image sensing device according to claim 6, wherein an initial value of a bin that is counted up in the second integration section is shifted by a value corresponding to the number of bins in the first blank section.

8. The image sensing device according to claim 1, wherein the second subframe includes:
a second exposure section configured to accumulate photocharges generated by detecting the reflected light; and
a second readout section configured to generate the image data corresponding to the accumulated photocharges.

9. The image sensing device according to claim 8, wherein the second exposure section includes:
a third integration section in which the photocharges are accumulated;
a third blank section in which the time-to-digital converter (TDC) is reset after lapse of the third integration section;
a fourth integration section in which the photocharges are accumulated after lapse of the third blank section; and
a fourth blank section in which the time-to-digital converter (TDC) is reset after lapse of the fourth integration section.

10. The image sensing device according to claim 9, wherein an initial value of a bin that is counted up in the fourth integration section is shifted by a value corresponding to the number of bins in the third blank section.

11. The image sensing device according to claim 1, wherein the number of histograms in the first subframe is different from the number of histograms in the second subframe.

12. The image sensing device according to claim 1, wherein: in the first subframe, the distance is repeatedly measured with a first cycle; and
in the second subframe, the distance is repeatedly measured with a second cycle, and
wherein
the second cycle is longer than the first cycle.

13. The image sensing device according to claim 1, wherein the distance calculator is configured to demodulate one distance data using distance data measurable in the first subframe and another distance data measurable in the second subframe.

14. The image sensing device according to claim 13, wherein the distance calculator is configured to calculate a maximum distance measurable by the demodulation based on a least common multiple (LCM) of a distance measurable in the first subframe and a distance measurable in the second subframe.

15. The image sensing device according to claim 1, wherein the distance calculator is configured to:
determine relevance of at least one of a distance measurable in the first subframe, a distance measurable in the second subframe, the number of repetitions of a distance cycle in the first subframe, the number of repetitions of a distance cycle in the second subframe, and an actual distance to the target object; and
specify a measured distance value based on the determined relevance.

16. The image sensing device according to claim 1, wherein the distance calculator is configured to perform the demodulation operation using a difference in measured distances between the first subframe and the second subframe.

17. The image sensing device according to claim 16, wherein the distance calculator is configured to:
compare the difference with a preset differential value; and
determine a repetition cycle of each of the first subframe and the second subframe based on a result of the comparison.

18. The image sensing device according to claim 1, wherein the distance calculator is configured to:
determine a peak position of the histogram; and
perform the demodulation operation based on a result of the determination.

19. The image sensing device according to claim 17, wherein the distance calculator is configured to:
calculate a difference between a peak position of the first subframe and a peak position of the second subframe;
compare the calculated difference with a preset differential value; and
determine the repetition cycle of each of the first subframe and the second subframe.

20. The image sensing device according to claim 19, wherein the distance calculator is configured to:
calculate a peak bin position after the demodulation operation based on the repetition cycle; and
perform a centroid operation within a specific range centered on the peak bin position.
